(19) United States
(12) Patent Application Publication
(10) Pub. No.: US 2026/0287482 A1
(43) Pub. Date: Sep. 24, 2026

(54) Vertical Test System Adapter Accessory

(71) Applicants: RTX Corporation, Farmington, CT (US); University of Connecticut, Farmington, CT (US)

(72) Inventors: Gabriel Millan Garcia, Manchester, CT (US); Juan Luis Marin, Bridgeport, CT (US); Thatcher Samuel Pierce Schechtman, Manchester, CT (US); Rajiv A. Naik, Glastonbury, CT (US); Brent William Barber, Tolland, CT (US); Richard William Pagel, JR.

(21) Appl. No.: 19/479,050

(22) PCT Filed: Apr. 26, 2024
(86) PCT No.: PCT/US2024/026509

§ 371 Date: Oct. 27, 2025

Related U.S. Application Data
(60) Provisional application No. 63/462,414, filed on Apr. 27, 2023.

(51) Int. Cl. G01N 3/04; G01N 3/06; G01N 3/10

(52) U.S. Cl. CPC G01N 3/04; G01N 3/066; G01N 3/10; G01N 2203/0017; G01N 2203/0019; G01N 2203/0048; G01N 2203/0254; G01N 2203/0435

(57) ABSTRACT

A test system (20) has: a base (30); first and second support posts (40A, 40B) extending upward from the base; and a crosshead (44) receiving the first and second support posts. The crosshead is movable along a vertical range of motion relative to the first and second support posts and lockable to the first and second support posts within that range of motion. An actuator (70) provides a vertical force between the base and the locked crosshead. The vertical force is converted to a horizontal force on a specimen (26).

### CROSS-REFERENCE TO RELATED APPLICATION

Benefit is claimed of U.S. Patent Application No. 63462414, filed Apr. 27, 2023, and entitled “Vertical Test System Adapter Accessory”, the disclosure of which is incorporated by reference herein in its entirety as if set forth at length.

### BACKGROUND

The disclosure relates to mechanical test systems. More particularly, the disclosure relates to an accessory for vertical servohydraulic test systems such as used in fatigue testing under tensile and/or compressive loads.

A well-developed art exists in vertical test systems (typically with bidirectional servohydraulic actuation for both tensile and compressive testing). Example systems include floor standing systems and tabletop systems. Example existing vertical servohydraulic test systems are made by Illinois Tool Works Inc., Glenview, Illinois, US and Bionix@ tabletop test systems and Landmark® tabletop and floor standing test systems of MTS Systems Corporation, Eden Prairie Minnesota, US.

Typical tabletop systems mount a single actuator to the crosshead to apply the bidirectional load across a load string. Typical floor standing systems mount a single actuator in the base (e.g., with its ram extending upward through a table section forming a top of the base). Alternative floor standing systems may have one actuator in the base and one mounted to the crosshead. Additional variations include adding torsional actuators to the load string to permit measurement of torsional/twist properties.

Conventional servohydraulic test systems are vertical systems configured to apply and measure forces vertically with the test specimens oriented in a vertical orientation. For certain applications, it is advantageous to apply, measure and control loads horizontally and have the test specimen oriented horizontally rather than vertically. For example, one example of a situation where a horizontal test is desirable relative to a vertical test is heated specimens. With vertical testing, there may be a thermal gradient along the length of the specimen due to convection. This is substantially reduced with horizontal testing. In such a horizontal test, a heater may be used. This may be a small resistive heater clamped around the specimen or may be an inductive coil encircling the specimen.

Dedicated horizontal servohydraulic test systems are available but have many disadvantages primarily due to their cost, inflexibility to support other testing, and large floor space requirements.

### SUMMARY

One aspect of the disclosure involves a test system comprising: a base; first and second support posts extending upward from the base; a crosshead receiving the first and second support posts, the crosshead movable along a vertical range of motion relative to the first and second support posts and lockable to the first and second support posts within that range of motion; and an actuator for providing a vertical force between the base and the locked crosshead. The system further comprises means for converting the vertical force to a horizontal force on a specimen.

In a further embodiment of any of the foregoing embodiments, additionally and/or alternatively, the means comprises: an upper pivot block and a lower pivot block mounted to transmit the vertical force; first and second guides receiving the first and second support posts, respectively, and movable along a vertical range of motion relative to the first and second support posts; first and second horizontal rails each mounted to the first and second guides; first and second horizontal guides each receiving the first and second horizontal rails and each movable along a respective horizontal range of motion; first and second upper pivot arms respectively having outboard end portions pivotally mounted to the first and second horizontal guides and having inboard portions pivotally mounted to the upper pivot block;

first and second lower pivot arms respectively having outboard end portions pivotally mounted to the first and second horizontal guides and having inboard portions pivotally mounted to the lower pivot block; and first and second fixtures for mounting a test specimen to transmit said horizontal force between the first and second horizontal guides through the test specimen.

In a further embodiment of any of the foregoing embodiments, additionally and/or alternatively, the means further comprises: a horizontal load cell in series with the test specimen between the first and second horizontal guides.

In a further embodiment of any of the foregoing embodiments, additionally and/or alternatively, the test system further comprises a vertical load cell transmitting and measuring the vertical force.

In a further embodiment of any of the foregoing embodiments, additionally and/or alternatively, the actuator is a servohydraulic actuator.

In a further embodiment of any of the foregoing embodiments, additionally and/or alternatively: if the vertical force is compressive, the horizontal force is tensile; and if the vertical force is tensile, the horizontal force is compressive.

In a further embodiment of any of the foregoing embodiments, additionally and/or alternatively, the test system further comprises: one or more actuators for moving the crosshead along said vertical range of motion relative to the first and second support posts; and one or more locks for locking the crosshead in a selectable position along the range of motion.

In a further embodiment of any of the foregoing embodiments, additionally and/or alternatively, the test system further comprises a pair of hydraulic lifting cylinders for moving the crosshead along the crosshead's vertical range of motion relative to the first and second support posts.

In a further embodiment of any of the foregoing embodiments, additionally and/or alternatively, the horizontal force is of greater magnitude than the vertical force.

In a further embodiment of any of the foregoing embodiments, additionally and/or alternatively, a method for assembling the test system comprises: slidingly mounting the means to the first and second support posts; and mounting the means between the actuator and a vertical load cell.

In a further embodiment of any of the foregoing embodiments, additionally and/or alternatively, the slidingly mounting the means to the first and second support posts comprises slidingly mounting guide rails to the first and second support posts.

In a further embodiment of any of the foregoing embodiments, additionally and/or alternatively, a method for using the test system comprises: installing the specimen; providing the vertical force via the actuator; and the means converting the vertical force to the horizontal force on the specimen.

In a further embodiment of any of the foregoing embodiments, additionally and/or alternatively, the converting comprises the actuator vertically compressing a linkage and the linkage tensioning the specimen.

In a further embodiment of any of the foregoing embodiments, additionally and/or alternatively, the means reverses the sign of the horizontal force relative to the vertical force.

A further aspect of the disclosure involves a vertical test system adapter for testing a specimen, the adapter comprising: an upper pivot block and a lower pivot block; first and second guides for slidingly receiving first and second support posts, respectively; first and second horizontal rails each mounted to the first and second guides; first and second horizontal guides each slidingly receiving the first and second horizontal rails; first and second upper pivot arms respectively having outboard end portions pivotally mounted to the first and second horizontal guides and having inboard portions pivotally mounted to the upper pivot block; first and second lower pivot arms respectively having outboard end portions pivotally mounted to the first and second horizontal guides and having inboard portions pivotally mounted to the lower pivot block; and first and second fixtures for mounting the test specimen to transmit a horizontal force between the first and second horizontal guides through the test specimen in response to a vertical force applied across the upper pivot block and lower pivot block.

In a further embodiment of any of the foregoing embodiments, additionally and/or alternatively, the adapter further comprises: a horizontal load cell in series with the mounted test specimen between the first and second horizontal guides.

In a further embodiment of any of the foregoing embodiments, additionally and/or alternatively, a test apparatus includes the adapter and further comprises: a base; first and second support posts extending upward from the base and respectively slidingly received by the first and second guides; a crosshead receiving the first and second support posts; and an actuator for applying between the base and the crosshead said vertical force across the upper pivot block and lower pivot block.

In a further embodiment of any of the foregoing embodiments, additionally and/or alternatively, a method for using the test apparatus comprises: installing the specimen to the first and second fixtures; providing the vertical force via the actuator causing relative movement of the upper pivot block and lower pivot block; the relative movement of the upper pivot block and lower pivot block causing pivoting of the first and second upper pivot arms and the first and second lower pivot arms so as to cause relative horizontal movement of the first and second horizontal guides; and measuring the horizontal force across the specimen

In a further embodiment of any of the foregoing embodiments, additionally and/or alternatively, the method further comprises measuring a deformation of the specimen.

In a further embodiment of any of the foregoing embodiments, additionally and/or alternatively, the relative horizontal movement of the first and second horizontal guides is a sliding movement along the first and second rails; and the relative movement of the upper pivot block and lower pivot block causes vertical sliding movement of the first and second guides along the first and second support posts respectively.

The details of one or more embodiments are set forth in the accompanying drawings and the description below. Other features, objects, and advantages will be apparent from the description and drawings, and from the claims.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a vertical test system with a horizontal test adapter attached.

FIG. 2 is a rearward view of the adapter with engaging components of the vertical test system schematically shown.

FIG. 3 is a rear view of the adapter of FIG. 2.

FIG. 4 is a side view of the adapter of FIG. 2.

FIG. 5 is a top view of the adapter of FIG. 2.

FIG. 6 is a central horizontal sectional view of the adapter of FIG. 2 taken along line 6 -6 of FIG. 3.

FIG. 7 is a central transverse vertical sectional view of the adapter of FIG. 2 taken along line 7 -7 of FIG. 4.

FIG. 8 is an offset transverse vertical sectional view of the adapter of FIG. 2 taken along line 8 -8 of FIG. 4.

Like reference numbers and designations in the various drawings indicate like elements.

### DETAILED DESCRIPTION

The disclosure involves a mechanism for a servohydraulic test system that converts an actuator vertical load to a horizontal load applied to the test specimen. The mechanism may be implemented as an accessory for or modification of a baseline vertical servohydraulic test system or as an original system (e.g., including one based on the design of a baseline vertical servohydraulic test system).

Example systems include floor standing systems and tabletop systems. Example baseline systems include: the INSTRON® 8802 floor standing test system, Illinois Tool Works Inc., Glenview, Illinois, US; and the Bionix® tabletop test systems and Landmark® tabletop and floor standing test systems of MTS Systems Corporation, Eden Prairie Minnesota, US.

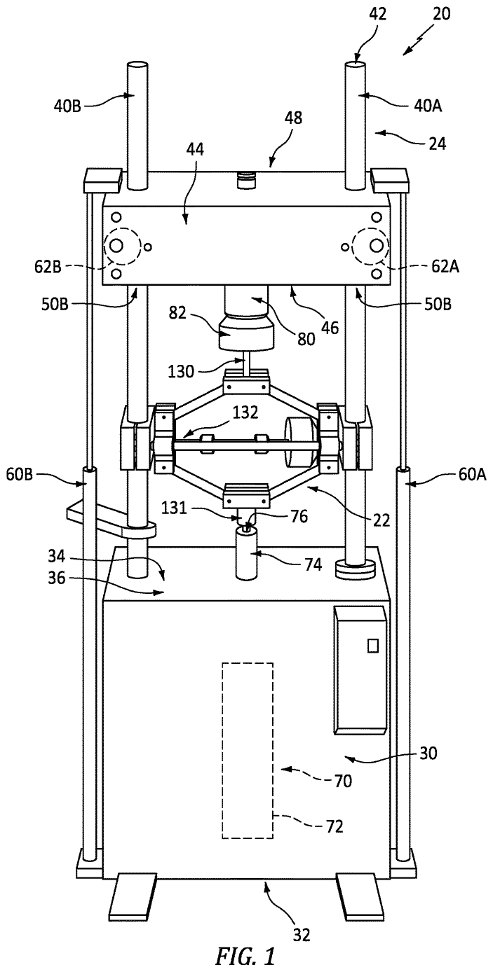

FIG. 1 shows a horizontal test system 20 formed by attaching an adapter accessory 22 to an otherwise conventional (baseline) vertical test system 24 to allow horizontal testing of a specimen 26.

The example illustrated baseline system is a particular floor standing system although other floor standing systems and tabletop systems may be used alternatively. The example baseline system has a single load actuator which is a servohydraulic actuator, although other actuator types and dual-actuator systems may be used.

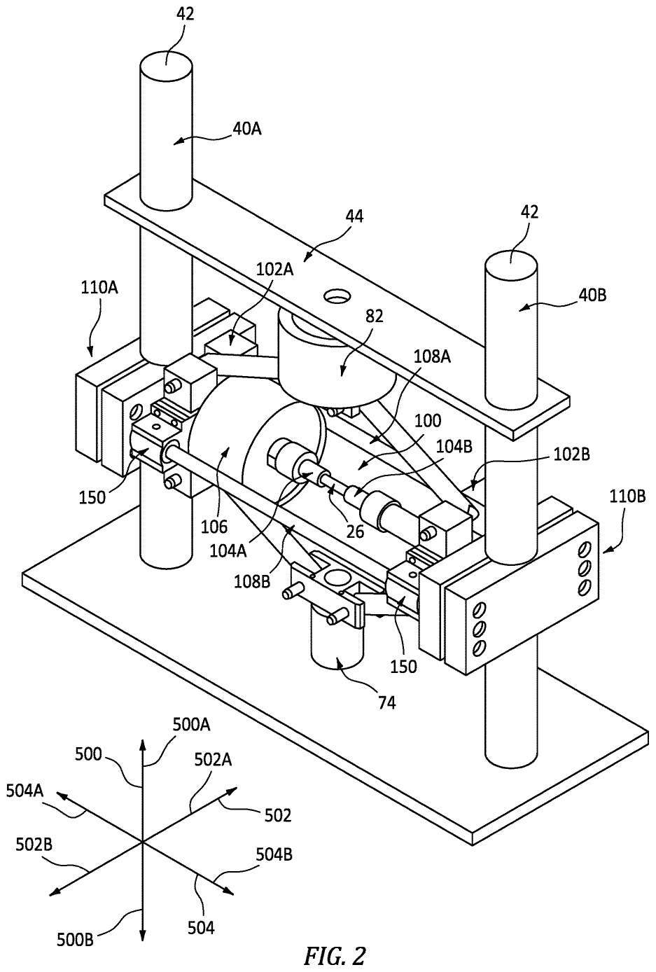

With reference to FIG. 2, a vertical direction 500 has upward and downward directions 500A and 500B, respectively. Similarly, a first horizontal direction has a forward direction 502A and a rearward direction 502B. In this example, forward and rearward are defined from the perspective of the machine itself facing the user rather than a user facing the machine. Similarly, an orthogonal second horizontal direction 504 has a leftward direction 504A and a rightward direction 504B.

The baseline system has a base section 30 having an underside 32 and a top 34. The example top is formed by a table section 36. The baseline system further includes a pair of left and right posts or columns 40A, 40B extending from lower ends (not shown) within the base 30 up through the top 34 to upper ends 42. A crosshead 44 spans the posts and has an underside 46, a top 48, and apertures 50A, 50B receiving the respective posts. The crosshead is slidingly vertically movable along the posts and lockable in place. Example apertures are formed by bushings (e.g., with a hydraulic or other lock discussed below).

An example movement may be achieved by lift actuators 60A, 60B. The example lift actuators 60A, 60B are hydraulic having cylinders mounted at left and right sides of the base and pistons/rams extending up from the cylinders and mounted to the crosshead proximate left and right sides of the crosshead. To lock the crosshead at a particular selected vertical position, the crosshead may include left and right locks 62A, 62B. These locks may be hydraulic or pneumatic clamps. Alternative lift actuators and locks are manual lift actuators and locks.

A load actuator 70 of the baseline system provides a vertical compressive or tensile force between the crosshead and the base. As noted above, the example load actuator 70 is a servohydraulic actuator with a cylinder 72 and associated other components within the base and an extensible and retractable piston or ram 74 extending upward from the base and having an upper end/top 76.

In the baseline system when operated as a vertical test system, a vertical load string (not shown) will be positioned between the crosshead underside 46 and ram top 76 to transmit the vertical compressive or tensile force through the specimen. To do so, the example vertical load string comprises first and second fixtures (e.g., grips) for engaging respective upper and lower end portions of the specimen and a load cell (force transducer) for measuring the applied/transmitted force. In one example, the lower fixture mounts directly to the ram (e.g., via internal thread in the ram or other attachment feature). The upper fixture may mount to the load cell. The load cell may, in turn, be mounted to the underside of the crosshead. Alternatively, for precise alignment, there may be an intervening alignment fixture 80 such as directly intervening between the crosshead underside 46 and the load cell 82.

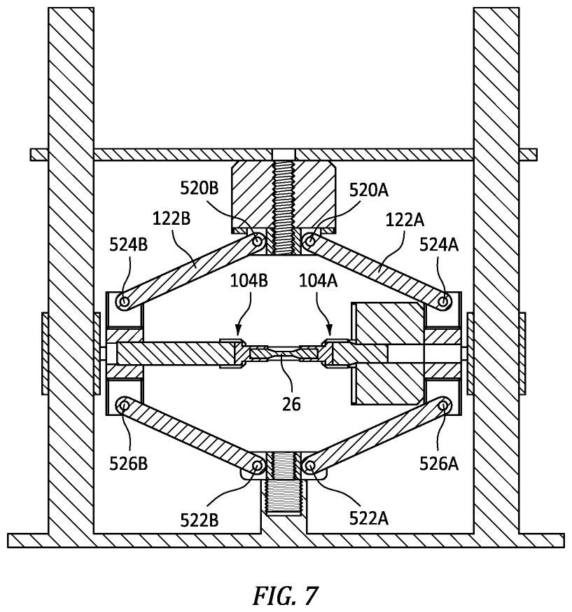

FIG. 1 shows an example alignment fixture 80 and load cell 82 carried over from the baseline. As so far described in this section, other than the adapter 22, all features are carried over from the baseline. The example adapter creates a horizontal load string 100 (FIG. 2) between left and right members (guides) 102A and 102B, respectively. The horizontal load string 100 includes left and right fixtures 104A, 104B for engaging the end portions of the specimen. These fixtures may be prior art or other fixtures appropriate to the particular specimen to be tested. In this particular example of a specimen and fixture configuration carried over from a particular baseline, FIGS. 6 and 7 show the specimen as having a central necked portion which defines a test section. At opposite ends, the specimen has external threads as example engagement features. These are threaded into complementary bores of the fixtures 104A, 104B. The example fixtures are each assemblies having an inner member bearing the internal thread and an outer collar bearing an internal thread engaged to the next component of the horizontal string (e.g., the connector/spacer 131 for the fixture 104B and a shaft threaded into the load cell 106 for the fixture 104A).

Similarly, the horizontal load string 100 includes a load cell 106 (horizontal load cell) for measuring the forces applied to the specimen through the horizontal load string. The horizontal load cell 106 may be similar to the baseline vertical load cell 82. However, due to force reduction or magnification (discussed below) it may be appropriate to have a greater or lower load rating on the horizontal load cell 106 versus the vertical load cell 82. The scale of the horizontal load cell may also be dependent on the particular specimen to be tested so as to provide a desired resolution of output.

Although it is possible to eliminate/delete the vertical load cell 82, it is advantageously maintained in order to make sure vertical operation of the machine stays within normal operating parameters.

The example members 102A, 102B are maintained in orientation by cooperating with front and rear horizontal guide rails 108A, 108B (e.g., formed of circular cylindrical carbon steel rod stock). The horizontal guide rails are mounted between respective left and right vertical rail guides (sliding post clamps) 110A, 110B which in turn are slidingly mounted to the left and right posts 40A, 40B, respectively. Respective left and right end portions of the guide rails are mounted in the left and right rail guides (e.g., through apertures to the front and rear, respectively, of the posts). The members 102A, 102B thus act as carriages movable along the guide rails.

Each of the example left and right vertical rail guides 110A, 110B comprises an inboard piece and an outboard piece with near semi-cylindrical recesses sandwiching the associated post in the assembled condition. The inboard face of the inboard piece has bores receiving associated portions of the two guide rails. The outboard piece and inboard piece may be secured to each other such as via threaded fasteners (e.g., bolts or screws) extending through one piece and into in the other (e.g., through-bores to then be held by nuts). The bolts are not so tight as to cause the vertical rail guide to grasp the post with any substantial frictional engagement. In one set of examples, the two pieces are non-metallic (e.g., formed of a polymer) so as to have relatively self-lubricating and non-scoring/wearing interaction with the post. Example material is polymeric such as polyethylene terephthalate glycol (PETG or PET-G) (e.g., 3D printed).

The members 102A, 102B (FIG. 2) each have a pair of front and rear apertures receiving the associated front or rear guide rail. For example, these apertures may be formed by bushings or bearings so as to form a linear bearing. In the illustrated example, members 102A, 102B each further comprise a pair of fore-and-aft bearing blocks 150 fastened to the main piece and containing a linear bearing (e.g., a linear ball bearing) or a lubricious bushing. The cooperation of the bearings with the guide rails helps maintain alignment of the members 102A, 102B to ensure sufficiently consistent and accurate measurements. Example bearing blocks have steel bodies. An example main body piece of each member 102A, 102B may be machined from aluminum billet stock. The example main body pieces are H-shaped with the four legs of each H having an aperture for the associated pivot pin. The crossbar of each H has a threaded bore or other mounting feature for mounting the associated load cell 106, spacer 132 (discussed below), or other intervening component of the horizontal load string. This bearing/bushing should react out bending or rotation of the guide rail and therefore should be high tolerance (vs. a loose fit linear bearing) to limit sagging. Thus, rigidity and close tolerance are desirable.

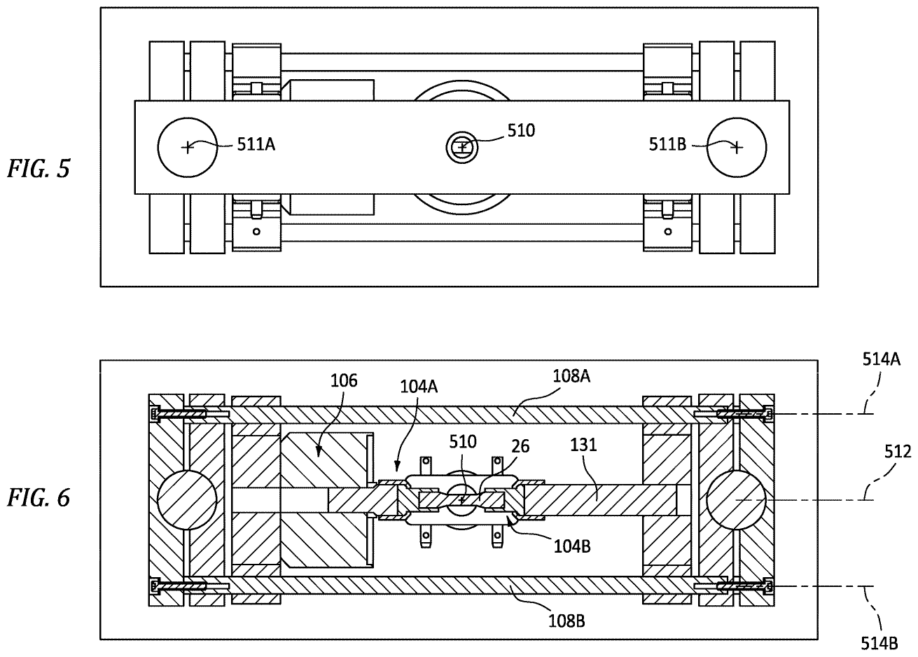

FIGS. 5&6 show a vertical load string axis 510, post axes 511A, 511B, a horizontal load string axis 512, and guide rail axes 514A, 514B.

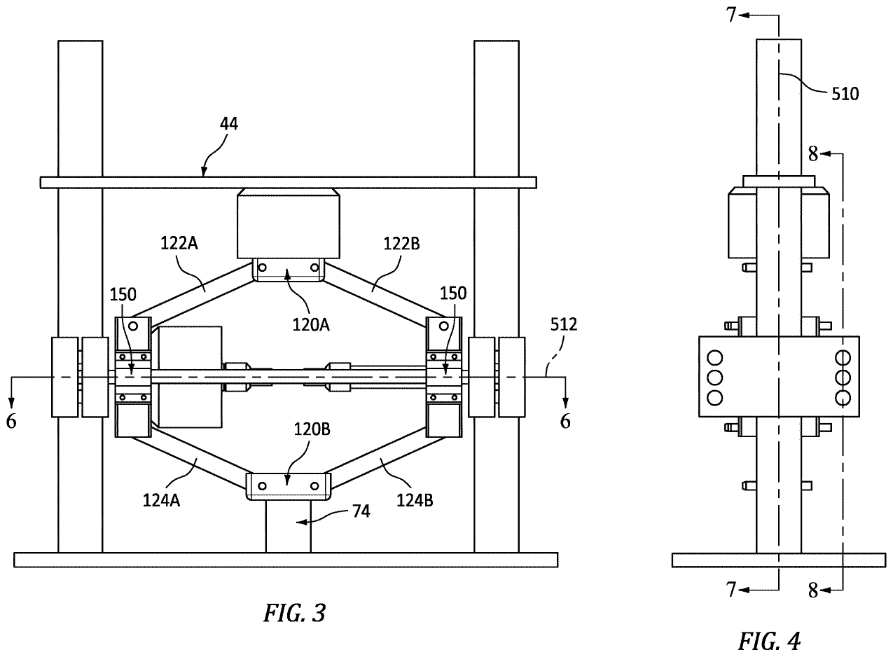

A force-transmitting linkage converts the vertical applied force between the ram 74 and crosshead 44 into horizontal force between the members 102A and 102B. The example linkage comprises an upper pivot block (or linkage union) 120A (FIG. 3) mounted relative to the crosshead and a lower pivot block (or linkage union) 120B mounted relative to the ram. Example pivot blocks 120A, 120B are machined from aluminum alloy. Each of these pivot blocks is pivotally mounted to a respective upper and lower pair of left and right pivot arms (links) (upper pair 122A, 122B, and lower pair 124A, 124B). Mounting is at respective upper inboard pivot axes 520A, 520B and lower inboard pivot axes 522A, 522B. The pivot arms extend to outboard ends pivotally mounted to the associated left or right member 102A, 102B for pivotal rotation about outboard pivot axes 524A, 524B and 526A, 526B. Thus, the members 102A, 102B also serve as pivot blocks. With the example H-section pivot block 102A, 102B main piece, the upper pair and lower pair of arms of each H form a clevis receiving an associated arm/link end portion. Example pivot arms are machined from carbon steel rod stock.

Example pivots are each formed by a pin (pivot pin) through a hole in the associated end sections of the associated pivot arms on the one hand and a hole in the associated end portion of the associated pivot block (two arms of the H in the example) on the other hand. Example pins are ball detent pins with a spring-loaded detent ball at one end and a spiral retention ring through a through-hole at the other end. Other pin configurations are possible. In the illustrations of FIGS. 2-8, there are through-holes for retention rings at both ends of each pin. As noted above, in the example, each of the left and right pivot blocks 102A, 102B comprises an assembly of an H-shaped central structure forming upper and lower clevises for receiving associated upper and lower pivot arms. Thus, the associated pivot hole goes through both arms. Example pins are stainless steel.

Accordingly, a vertical compressive force will tend to drive the upper and lower pivot blocks toward each other tending to rotate the pivot arms into more a horizontal orientation and driving the left and right members 102A, 102B horizontally apart along the guide rails. Thus, a vertically compressive/compression force becomes a horizontal tension force. Similarly, withdrawing the ram to create vertical tension will produce opposite rotation of the pivot arms and draw the members 122A and 122B toward each other producing horizontal compression across the horizontal load string.

Because, in this illustrated example, the crosshead remains fixed and there is essentially no movement in the load cell 82, extending or withdrawing the ram will slightly elevate a lower portion of the horizontal load string. Thus, the left and right vertical rail guides 110A, 110B will slide slightly along the associated left and right posts.

In the example, the vertical and horizontal load strings include connectors/spacers 130, 131, 132 (FIG. 1). These may serve slightly different purposes. Because of the adjustable height of the crosshead, the vertical spacers 130, 131 may be relatively unnecessary. The lower vertical spacer 131 helps vertically position the horizontal load string at a desired height (e.g., an easy ergonomic height for servicing). Additionally, particularly the upper vertical spacer 130 may help provide access and space the load cell 82 away from the horizontal string which may be desirable for thermal isolation when dealing with a heated specimen. Example spacers 130 and 132 are threaded carbon steel rods.

The horizontal connector/spacer 132 is relevant to set the neutral position of the linkage and, thereby, the leverage exerted by the vertical actuator 72 on the horizontal string. In the illustrated example, in the neutral condition (specimen installed and no load) the pivot arms are closer to horizontal than to vertical (e.g., measured as an angle between their two pivot points). With such a neutral condition, there is force magnification. A given vertical force will produce a greater horizontal force. If, instead, the pivot arms were closer to vertical than horizontal in the neutral condition, the horizontal force would be smaller than the vertical force.

Thus, for a given specimen and fixture, use of a shorter connector/spacer relative to a longer connector/spacer will decrease force magnification. Thus, relative to the illustrated condition, progressively shorter spacer/connectors would cause the neutral condition to first shift the pivot arms toward a 45°angle of zero force magnification and, thereafter, to less than 45°off vertical so as to cause force reduction instead of magnification.

The example upper vertical spacer and horizontal spacer are simple threaded rods. These may be set for a given length (e.g., threaded to bottom out in the associated components they mount to). Alternative spacers may be adjustable (e.g., as in a turnbuckle or other). The lower vertical spacer is merely a short block to raise the height of the adapter.

Various additional control and measurement features are not disclosed or mentioned above but may be as conventional and may be carried over from the baseline. For example, extensiometers may be included (e.g., optical or strain gauge) for measuring deformation. Similarly, the optional heater is not shown.

Component materials and manufacture techniques and assembly techniques may be otherwise conventional. Additionally, in one example of an assembly/retrofit process, fixtures (grips, etc.—not shown) may be removed from the vertical load string of the baseline. The connectors/spacers 130, 131, if used or if not already part of the baseline vertical load string may then be attached. The upper and lower pivot blocks may be attached to the vertical load cell 82 and ram 74 (or spacer 131 if present) respectively (e.g., via direct threading or using threaded fasteners). The various links 122A, 122B, 124A, 124B may then be attached to the associated pivot block via the associated pin.

To support the sliding post clamps 110A, 110B, temporary clamps may be placed on the posts to support the sliding post clamps 110A, 110B. These may be pre-installed split ring clamps that are preinstalled to the posts and normally reside low (such as atop the base top). They may be slid up and tightened (e.g., manually via fasteners).

One can then attach both halves of a first of the sliding post clamps 110A, 110B (no guide rods yet attached) to the associated post 40A, 40B atop the temporary clamp. This is done by the upper and lower bolts/screws (and nuts in the example) on each side. In the example, annular spacers (e.g., aluminum rings) may contact the facing surfaces of the halves of each sliding post clamp 110A, 110B. Each fastener that spans the gap between such halves may be encircled by such a spacer. If the clamp grips the post too tightly to slide sufficiently freely, a longer spacer may be used, a washer added to further space, or the like. If too loose, a shorter spacer may be used, a washer removed, or the like. Compliance of the material will allow some range of adjustment based on tightness. For example, tightening fasteners may cause the aluminum spacer to locally deform the contacting surfaces and thus tighten the clamp to the post, slightly. Alternatively, the spacer may be relatively compressible.

Then, the inboard half of the other of the sliding post clamps 110A, 110B may be put in place atop the other temporary clamp. The pivot blocks 102A, 102B may be put in place and the guide rails inserted through the unpaired second rail guide inboard half, the pivot blocks 102A, 102B, and into or through the inboard half of the first rail guide.

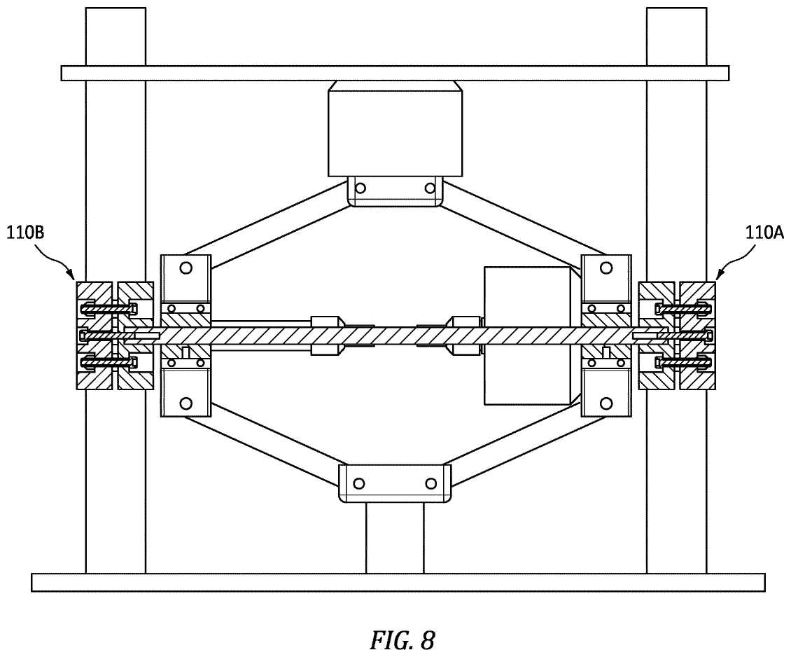

In one example of the rail guides, both inboard halves have through-holes for the rods. Thus, the insertion of the guide rods causes the guide rods to pass through the inboard half of the first rail guide so as to bottom out at the inboard face of the outboard half of the first rail guide. Thereafter, the outboard half of the second rail guide may be attached. Its inboard face will contact or closely spacedly serve as a stop for the adjacent ends of the rods. However, in the illustrated FIG. 8 configuration, there is asymmetry between the inboard halves of the sliding post clamps 110A and 110B. The sliding post clamp 110B is the first to be installed.

The example FIG. 8 outboard halves of the sliding post clamps 110A and 110B are identical. Each guide rod-receiving compartment/bore/hole of the inboard half of the sliding post clamp 110B has an internal shoulder forming a stop surface for the adjacent end of the associated guide rod. In this particular example, the stop surface is annular, with a through-hole coaxial with a through-hole in the outer member. This allows a fastener (screw or bolt) to extend through the outboard half, through the hole, and into a threaded terminal bore of the guide rod to secure the guide rod axially in place. In distinction, the inboard half of the sliding post clamp 110A has the aforementioned full through-bore allowing it to be slid along the guide rods to allow clearance between the posts and then drawn outward along the guide rods to seat relative to the associated post.

In the illustrated example, the end of the guide rod received in the sliding post clamp 110A has a similar threaded bore to the opposite end received in the sliding post clamp 110B. However, this is not necessary as discussed below. In the illustrated example, a similar bolt/screw is threaded through the sliding post clamp 110A into the guide rod. This, however, may be relatively lightly tightened to not interfere with the sliding action of the sliding post clamps. Optionally, however, there may be no screw/bolt and no associated threaded aperture. In such a case, for simplicity of manufacture, there still may be unused middle holes in the outboard half of the sliding post clamp 110A so that only a single part configuration is needed for both outboard post clamp halves. In such a situation, the securing at one end is sufficient. However, as noted above, even such securing is not needed as long as the guide rods are otherwise axially captured.

The various links may then be attached to the left and right pivot blocks 102A, 102B via the associated pivot pins. Again, the example pivot pins may be inserted from one end through the various components and then the retaining ring may be put through the aperture of the inserted end (as well as the other end if needed).

In use, control and operation may be as otherwise conventional. FIG. 1 shows a control system (e.g., a computer or micro-controller) for running the system receiving inputs from various sensors including the load cells, extensiometers (if any), and the like. Such control system also controls the various actuators, particularly the main vertical actuator. Again, this represents just one particular baseline and other baselines may be used. The control may be modified so as to monitor and display outputs of both load cells when both are present. Thus, the control system may be modified to have limit settings for both load cells to prevent damage to the system. The control system also may have health diagnosis parameters included which may use outputs of the two cells to determine mechanical wear or other damage.

Thus, the control system may control actuation and monitor behavior for various static or dynamic tests such as tensile strength tests and fatigue tests (e.g., oscillating fully reversed tension-compression or just cyclic tension or cyclic compression).

As noted above, the linkage may provide leverage such that the horizontal force differs from the vertical force applied. The leverage reflects a combination of: 1) the pivot arm lengths; and 2) the neutral position. The latter may be set by selecting the length of the connector/spacer 132 and adjusting the crosshead position accordingly.

Relative to systems that can be reoriented between vertical and horizontal, the adapter may eliminate the time and costs associated with re-orienting the entire test frame from a vertical to a horizontal position. It may similarly eliminate the safety and ergonomic risk involved with heavy lifting and rigging required to re-orient test rigs horizontally.

Use of the adapter may reduce the footprint by about one third needed for a reorientable test rig.

Use of the adapter may increase the useability and application of large test frame forces in multiple orientations (i.e., the rig can quickly and easily be converted from horizontal force application to vertical).

Use of the adapter's linkage may broaden the baseline system's force range. It can multiply or reduce the applied forces depending on the position of the crosshead and pivot arm lengths.

Although shown in the context of a two-post system, the accessory may be implemented in other systems such as single-post and four-post systems. In the four-post system, one option is to use essentially the same accessory as the two-post system but have the accessory extend diagonally between a diagonally opposite pair of posts. Another option is that the left and right sliders would accommodate both associated left or right posts, respectively, and the horizontal load string would extend from a left end centrally between the left posts and a right end centrally between the right posts.

A further possible advantage of the 3D printing of the sliding post clamps 110A and 110B is that the sliding post clamps will be particular to one diameter of post. It would be convenient to print a set for a different post diameter, allowing reuse of some or all of the other components (the guide rails would need to be replaced if a different length was required, but producing such different length is a relatively non-labor-intensive task).

Although the leverage/mechanical advantage may be needed to apply more force than the actuator is capable of applying, there may be advantages to positive magnification (force transfer ratio) even when the horizontal load requirement is not greater than the actuator is capable of applying vertically. For example, the horizontal load string length may be set by wanting to have the specimen centered. The length of the load cell to one side is set and that sets the minimum length of the spacer 132. With such minimum length set, reducing magnification would involve lengthening the pivot arms. That lengthening may increase stress on the arms and other components and decrease precision (thus requiring some combination of stronger materials and greater size to compensate if possible). There are industry standards for the alignment and precision of measurement (e.g., ASTM E1012-19 (“Standard Practice for Verification of Testing Frame and Specimen Alignment Under Tensile and Compressive Axial Force Application”)). There are also issues of maintaining margins of safety to avoid material failures during use (e.g., fatigue after prolonged use). The particular dimensions of components (e.g., thicknesses in addition to link length and other aspects of linkage geometry) and requirements for/selection of their materials may be optimized via computer modeling (e.g., ANSYS® software of Ansys, Inc., Canonsburg, Pennsylvania) optionally with feedback from physical testing to achieve desired precision and safety.

It thus may be advantageous to have nominal magnifications (force transfer ratios) in a range of 1.5:1 to 2.5:1 even when that is not needed based on insufficient capacity of the vertical actuator. In use, tolerances and deflections will typically cause a slight increase in force magnification with load.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline vertical test system configuration, baseline specimen configuration and/or material, and the like, details of such baseline may influence details of particular implementations. Accordingly, other embodiments are within the scope of the following claims.

What is claimed is:

1. A test system (20) comprising:
a base (30);
first and second support posts (40A, 40B) extending upward from the base;
a crosshead receiving the first and second support posts, the crosshead:
movable along a vertical range of motion relative to the first and second support posts; and
lockable to the first and second support posts within that range of motion; and
an actuator (70) for providing a vertical force between the base and the locked crosshead, and further comprising:
means (22) for converting the vertical force to a horizontal force on a specimen (26).

2. The test system of claim 1 wherein the means (22) comprises:
an upper pivot block (120A) and a lower pivot (120B) block mounted to transmit the vertical force;
first and second guides (110A, 110B) receiving the first and second support posts, respectively, and movable along a vertical range of motion relative to the first and second support posts;
first and second horizontal rails (108A, 108B) each mounted to the first and second guides;
first and second horizontal guides (102A, 102B) each receiving the first and second horizontal rails and each movable along a respective horizontal range of motion;
first and second upper pivot arms (122A, 122B) respectively having outboard end portions pivotally mounted to the first and second horizontal guides and having inboard portions pivotally mounted to the upper pivot block;
first and second lower pivot arms (124A, 124B) respectively having outboard end portions pivotally mounted to the first and second horizontal guides and having inboard portions pivotally mounted to the lower pivot block; and
first and second fixtures (104A, 104B) for mounting a test specimen to transmit said horizontal force between the first and second horizontal guides through the test specimen.

3. The test system of claim 2 wherein the means further comprises:
a horizontal load cell (160) in series with the test specimen between the first and second horizontal guides.

4. The test system of claim 3 further comprising:
a vertical load cell (82) transmitting and measuring the vertical force.

5. The test system of claim 1 wherein:
the actuator is a servohydraulic actuator.

6. The test system of claim 1 wherein:
if the vertical force is compressive, the horizontal force is tensile; and
if the vertical force is tensile, the horizontal force is compressive.

7. The test system of claim 1 further comprising:
one or more actuators (60A, 60B) for moving the crosshead along said vertical range of motion relative to the first and second support posts; and
one or more locks for locking (62A, 62B) the crosshead in a selectable position along the range of motion.

8. The test system of claim 1 and further comprising:
a pair of hydraulic lifting cylinders (60A, 60B) for moving the crosshead along the crosshead's vertical range of motion relative to the first and second support posts.

9. The test system of claim 1 wherein:
the horizontal force is of greater magnitude than the vertical force.

10. A method for assembling the test system of claim 1, the method comprising:
slidingly mounting the means to the first and second support posts; and
mounting the means between the actuator and a vertical load cell.

11. The method of claim 10 wherein:
the slidingly mounting the means to the first and second support posts comprises slidingly mounting guide rails (108A, 108B) (to the first and second support posts.

12. A method for using the test system of claim 1, the method comprising:
installing the specimen;
providing the vertical force via the actuator; and
the means converting the vertical force to the horizontal force on the specimen.

13. The method of claim 12 wherein:
the converting comprises the actuator vertically compressing a linkage and the linkage tensioning the specimen.

14. The method of claim 12 wherein:
the means reverses the sign of the horizontal force relative to the vertical force.

15. A vertical test system adapter (22) for testing a specimen (26), the adapter comprising:
an upper pivot block (120A) and a lower pivot block (120B);
first and second guides (110A, 110B) for slidingly receiving first and second support posts, respectively;
first and second horizontal rails (108A, 108B) each mounted to the first and second guides;
first and second horizontal guides (102A, 102B) each slidingly receiving the first and second horizontal rails;
first and second upper pivot arms (122A, 122B) respectively having outboard end portions pivotally mounted to the first and second horizontal guides and having inboard portions pivotally mounted to the upper pivot block;
first and second lower pivot arms (124A, 124B) respectively having outboard end portions pivotally mounted to the first and second horizontal guides and having inboard portions pivotally mounted to the lower pivot block; and
first and second fixtures (104A, 104B) for mounting the test specimen to transmit a horizontal force between the first and second horizontal guides through the test specimen in response to a vertical force applied across the upper pivot block and lower pivot block.

16. The adapter of claim 15 further comprising:
a horizontal load cell (60) in series with the mounted test specimen between the first and second horizontal guides.

17. A test apparatus (20) including the adapter of claim 15 and further comprising:
a base;
first and second support posts (40A, 40B) extending upward from the base and respectively slidingly received by the first and second guides;
a crosshead (44) receiving the first and second support posts; and
an actuator (70) for applying between the base and the crosshead said vertical force across the upper pivot block and lower pivot block.

18. A method for using the apparatus of claim 17, the method comprising:
installing the specimen to the first and second fixtures;
providing the vertical force via the actuator causing relative movement of the upper pivot block and lower pivot block;
the relative movement of the upper pivot block and lower pivot block causing pivoting of the first and second upper pivot arms and the first and second lower pivot arms so as to cause relative horizontal movement of the first and second horizontal guides; and
measuring the horizontal force across the specimen

19. The method of claim 18 further comprising:
measuring a deformation of the specimen.

20. The method of claim 18 wherein:
the relative horizontal movement of the first and second horizontal guides is a sliding movement along the first and second rails; and
the relative movement of the upper pivot block and lower pivot block causes vertical sliding movement of the first and second guides along the first and second support posts respectively.
